(19) United States
(12) Patent Application Publication
(10) Pub. No.: US 2009/0158079 A1
(43) Pub. Date: Jun. 18, 2009

(54) Fault information processing system and method for vehicle

(75) Inventors: Tae Young Chung, Seoul (KR); Hyung Bin Ihm, Seoul (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 12/214,751

(22) Filed: Jun. 21, 2008

(30) Foreign Application Priority Data
Dec. 13, 2007 (KR) 10-2007-0129667

(51) Int. Cl. G06F 11/07; G06F 11/30

(52) U.S. Cl. 714/2; 714/E11.179; 714/E11.029

(57) ABSTRACT

The present invention relates to a fault information processing system and method for a vehicle, which can satisfy a short control cycle to thereby reduce the burden applied to the CPU and enables significant fault information (freeze frame) to be frozen. To this end, this invention features that the fault detection unit, the fault processing unit, the fault management unit having independent control cycles process all the faults occurred depending on a priority in such a fashion that fault-related data (freeze frame) is frozen immediately after the occurrence of a fault irrespective of the type of the occurred fault and the priority. Also, the fault management unit retrieves the occurred fault at an independent control cycle, combines the previously frozen fault-related data and the occurred fault, and stores corresponding fault information in a buffer unit.

### CROSS-REFERENCE TO RELATED APPLICATION

This application claims the benefit under 35 U.S.C. §119(a) of Korean Patent Application No. 10-2007-0129667 filed on Dec. 13, 2007, the entire contents of which are incorporated herein by reference.

### BACKGROUND

(a) Technical Field

The present invention relates to a fault information processing system and method for a vehicle. More particularly, the present invention relates to a fault information processing system and method for a hybrid vehicle, in which when a fault within a hybrid system is processed and controlled.

(b) Background Art

In general, a hybrid vehicle in a broad meaning refers to a vehicle which is driven by an efficient combination of at least two different power sources. But, in most case, it refers to a vehicle which is driven by an engine (internal combustion engine) generating a torque through the combustion of a fuel (fossil fuel such as gasoline) and an electric motor generating a torque through power of a battery, which is called a hybrid electric vehicle (HEV).

Currently, in accordance with the demand for the improvement of gas mileage and the development of more environmentally friendly products, a research on the HEV is in progress more actively.

As known in the art, a hybrid vehicle enables the selection and conversion of an electric vehicle (EV) mode in which the vehicle is driven by using only a torque of the electric motor, an engine mode in which the vehicle is driven by using only a torque of the engine, and a hybrid electric vehicle (HEV) mode in which the vehicle is driven by using the torques of both the engine and the electric motor.

Such a hybrid vehicle has an advantage in that the mechanical energy of the engine and the electric energy of the battery can be used together so as to efficiently utilize energy. Also, the hybrid vehicle has an additional advantage in that the fuel consumption rate of the vehicle can be improved by using the optimal operational zone of the engine and the electric motor as well as energy can be recovered by the electric motor during the braking operation to thereby enable efficient utilization of energy.

The hybrid vehicle is mounted with a hybrid control unit (HCU) for controlling the overall operation of the vehicle. The hybrid vehicle also includes a controller for controlling each device constituting the vehicle.

For example, the hybrid vehicle includes an engine control unit (ECU) (also called ‘engine ECU’ or ‘engine management system (EMS)’) for controlling the overall operation of the engine, a motor control unit (MCU) for controlling the overall operation of an electric motor, a transmission control unit (TCU) for controlling a transmission, a battery management system (BMS) for monitoring and managing the state of a battery, a full auto temperature controller (FATC), etc.

The HCU is the uppermost controller of the respective controllers. The respective controllers are connected to a high-speed CAN communication line centering on the HCU so that an upper controller transmits a command to a lower controller while information is received and transmitted between the controllers.

In addition, the hybrid vehicle is mounted with a main battery (high-voltage battery) for supplying a drive power of an electric motor (drive motor) and an auxiliary battery (low-voltage battery) for supplying a drive power of vehicle electrical equipment. A low voltage (LV) DC-DC converter (hereinafter, abbreviated as ‘LDC’) for conversion of the output voltage between high voltage and low voltage is connected to the auxiliary battery and a main relay for controlling the supply of the high-voltage power.

The high-voltage battery supplies necessary power while repeatedly being charged and discharged. The electric motor receives the power from the high-voltage battery to perform the motoring operation to drive the vehicle, or inversely generate electricity using the kinetic energy of the vehicle to produce electric energy which will be in turn charged in the high-voltage battery.

Further, the LDC is a device serving as an alternator of a vehicle. The main function of the LDC is to supply power to a 12V electrical equipment load and converts high-voltage DC voltage output from the high-voltage battery into low-voltage DC voltage to charge the auxiliary battery.

Moreover, the high-voltage battery supplies (discharges) the electric energy to the electric motor during the motor assist mode, and stores (charges) the electric energy in the electric motor during the regenerative braking mode or the engine driving mode. In this case, the BMS transmits data signals indicative of a state of charge (SOC), an available charger power, an available discharge power and the like to the HCU and the MCU so as to perform manage safety and lifespan of the battery.

In the meantime, when a fault occurs in a system within the vehicle, it is required to be processed and controlled. Conventionally, all the faults occurred are controlled collectively and fault information is stored according to the sequence in which each fault occurred.

The hybrid vehicle has higher frequency of fault occurrence, its fault control is more complicated, and its control cycle is shorter, as compared to a non-hybrid vehicle.

Thus, the collective fault control adds a significant amount of burden to the CPU due to the short control cycle. Also, fault information stored in an existing manner does not provide proper information necessary for fault diagnosis of the hybrid system.

The information disclosed in this Background section is only for enhancement of understanding of the background of the invention and should not be taken as an acknowledgment or any form of suggestion that this information forms the prior art that is already known to a person skilled in that art.

### SUMMARY OF THE DISCLOSURE

The present invention has been made in an effort to solve the above problems occurring in the prior art, and one of the objects of the present invention is to provide a fault information processing system and method for a vehicle, which can satisfy a short control cycle, which is the characteristic of a hybrid vehicle system, to thereby reduce the burden applied to the CPU and enable significant fault information (freeze frame) to be frozen.

In order to accomplish the above object, in one aspect, the present invention provides a fault information processing system for a vehicle, which performs the process and the control of a fault occurred within the vehicle, and stores data for managing the occurred fault, the fault information processing system comprising: a fault detection unit for detecting the occurrence of a fault from each system within the vehicle and generating a signal informing the occurrence of the fault; a fault processing unit for receiving the fault occurrence informing signal from the fault detection unit and performing a proper process of the fault to protect the system; a fault management unit for receiving the fault occurrence informing signal from the fault detection unit and managing fault information necessary for diagnosis and repair of the fault; and

a buffer unit for storing fault-related data frozen by the fault detection unit 11a immediately after the occurrence of the fault.

In another aspect, the present invention provides a fault information processing method for a vehicle, which performs the process and the control of a fault occurred within the vehicle, and stores data for managing the occurred fault, the fault information processing method comprising the steps of: allowing a fault detection unit to detect the occurrence of a fault from each system within the vehicle and generate a signal informing the occurrence of the fault; allowing a fault processing unit to receive the fault occurrence informing signal from the fault detection unit and perform a proper process of the fault to protect the system; and allowing a fault management unit to receive the fault occurrence informing signal from the fault detection unit and manage fault information necessary for diagnosis and repair of the fault.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

Other aspects of the invention are discussed infra.

### BRIEF DESCRIPTION OF THE DRAWINGS

FIG. 1 is a schematic block diagram showing the main construction of a hybrid vehicle to which the present invention is applied;

FIG. 2 is a block diagram showing the construction of a fault information processing system according to the present invention;

FIG. 3 is a flowchart showing a fault information processing process according to the present invention; and

FIG. 4 is a view showing a method of determining a priority by fault in the fault information processing process according to the present invention.

Reference numerals set forth in the Drawings includes reference to the following elements as further discussed below:

| | |
|---|---|
| 1: high-voltage battery | 2: main relay |
| 3: capacitor | 10: MCU |
| 11: controller | 11a: fault detection unit |
| 11b: fault processing unit | 11c: fault management unit |
| 12: driver | 13: power supply |
| 14: memory | 15: drive motor |
| 20: ECU | 21: engine |
| 30: LDC | 31: electrical equipment load |

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

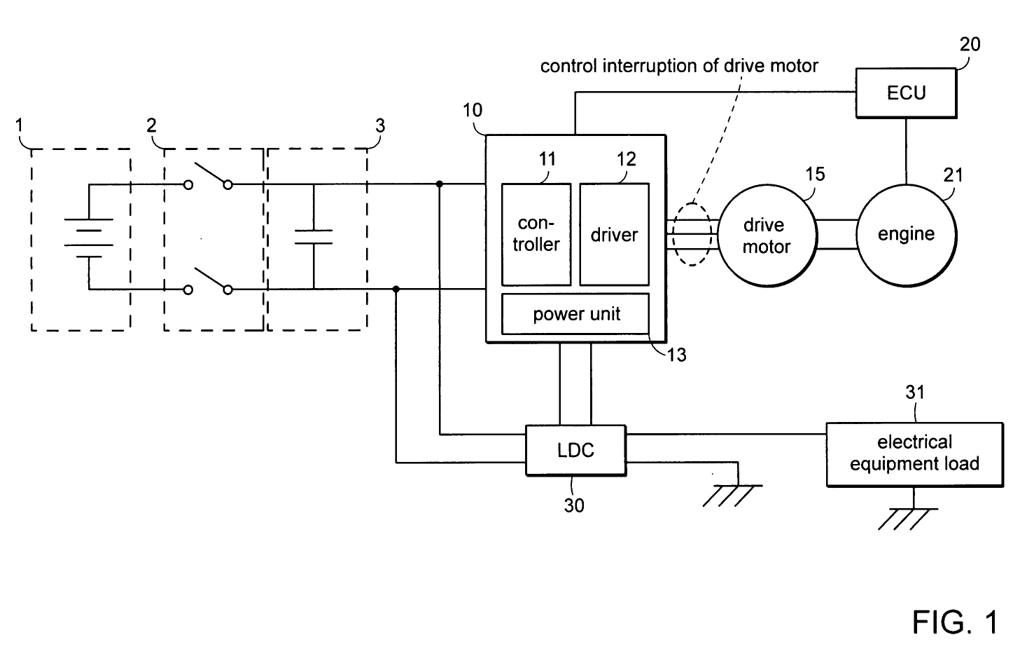

FIG. 1 is a schematic block diagram showing the main construction of a hybrid vehicle to which the present invention is applied.

As shown in FIG. 1, the hybrid vehicle includes a high-voltage battery 1, a main relay 2, a capacitor 3, an MCU 10, a drive motor 15, a low voltage DC-DC converter (LDC) 30, an engine 21, and an engine control unit (ECU) (or an engine management system (EMS) 20.

The main relay 2 controls the supply of power from the high-voltage battery 1. The MCU 10 controls the drive motor 15 while applying the power from the high-voltage battery 1 to the drive motor. The LDC 30 is adapted to be driven in response to a drive signal from the MCU 10 so as to supply the power to a vehicle electrical equipment load 31. The ECU 20 controls the overall operation of the engine 21 in cooperation with the MCU 10. The drive motor 15 provides a drive force to drive a vehicle under the control of the MCU 10. The engine 21 provides a drive force to drive a vehicle under the control of the ECU 20.

In this case, the control of a fault of a hybrid system is performed by the MCU 10. The MCU 10 includes a controller (CPU) 11, a driver 12, a power supply 13, and a memory (for example, EEPROM) (not shown in FIG. 1).

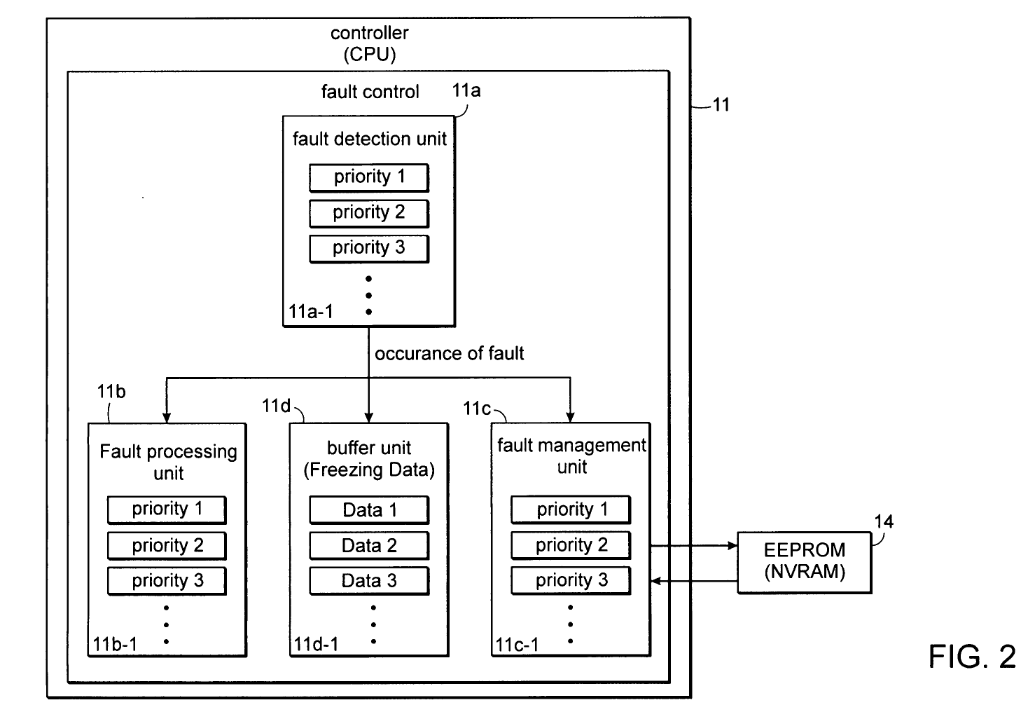

Among the constituent elements of the MCU 10, the controller 11 performs the process and control of a fault, and the memory (EEPROM) (indicated by reference numeral 14 in FIG. 2) associated with the controller 11 serves to store fault information.

In addition, the controller 11 performs the functions of the drive motor control, the vehicle control and the input/output control besides performing the process and control of the fault.

FIG. 2 is a block diagram showing the inner construction of a fault information processing system as the controller 11 of the ECU according to the present invention.

As shown in FIG. 2, the controller 11 includes a fault detection unit 11a, a fault processing unit 11b and a fault management unit 11c so as to perform the process and control of the fault. The present invention employs a method in which the fault detection unit 11a, the fault processing unit 11b and the fault management unit 11c perform the control of the fault distributedly, and a method in which fault information is most-preferentially frozen upon the occurrence of a fault and then the fault occurrence is preferentially retrieved in the order in which a fault management control cycle becomes shorter to thereby combine the occurred fault and the frozen fault information (freeze frame).

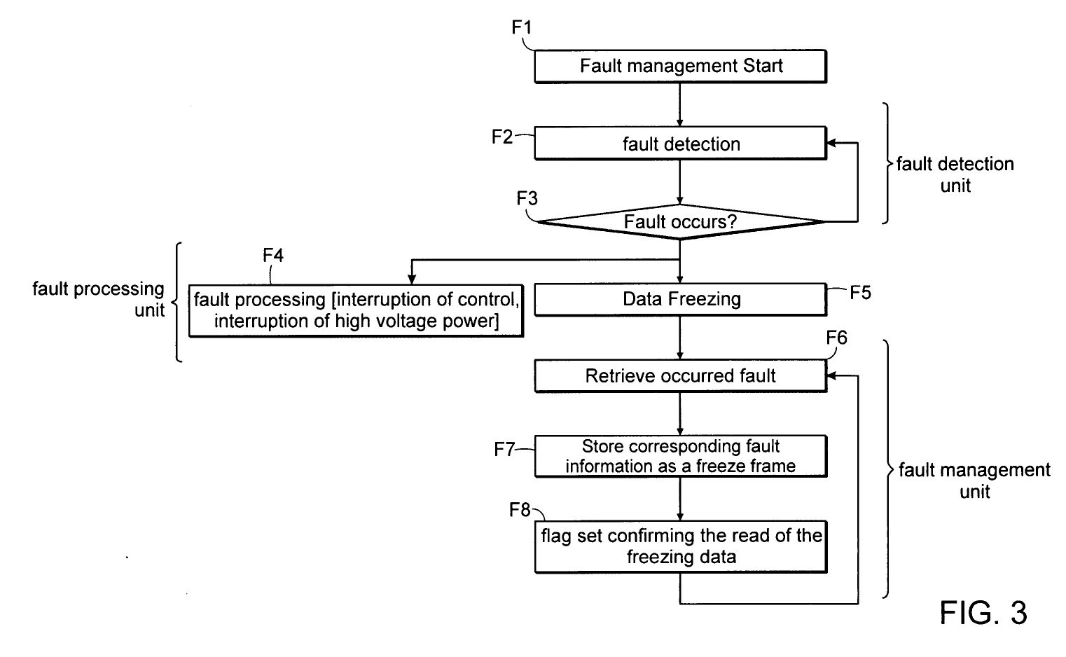

FIG. 3 is a flowchart showing a fault information processing process according to the present invention. The fault information processing process of the present invention will be described hereinafter with reference to FIG. 3.

The fault detection unit 11a performs the detection of all the faults possible to occur in a hybrid vehicle system, and generates a signal informing the occurrence of the fault for application to the fault processing unit 11b and the fault management unit 11c.

When the fault detection unit 11a detects the occurrence of a fault from each system within the hybrid vehicle and applies the signal informing the occurrence of the fault to the fault processing unit 11b and the fault management unit 11c, the fault processing unit 11b receives the fault occurrence informing signal from the fault detection unit 11a to thereby perform a proper process of the fault, for example, interruption of the control, interruption of the supply of high voltage power or the like, for the protection of the hybrid system.

Also, the fault management unit 11c receives the fault occurrence informing signal from the fault detection unit 11a to thereby manage fault information necessary for diagnosis and repair of the fault.

Generally, the detection and processing of the fault requires a short control cycle, but the fault information management does not require a control cycle as short as that of the detection and processing of the fault.

However, although the control cycle for the fault management is set long, fault-related data (freeze frame) at the time of occurrence of the fault must be frozen immediately after the occurrence of the fault. Otherwise, it is impossible to freeze significant data in view of the characteristic of a short control cycle of the hybrid system.

According to the present invention, the fault detection unit 11a, the fault processing unit 11b and the fault management unit 11c can perform the fault process at different control cycles, respectively. In this case, each or some of the faults possible to occur may be assigned with a priority to allow the control cycles of the fault detection, the fault process and the fault management to vary depending on the type (11a-1, 11b-1, 11c-1) of a fault.

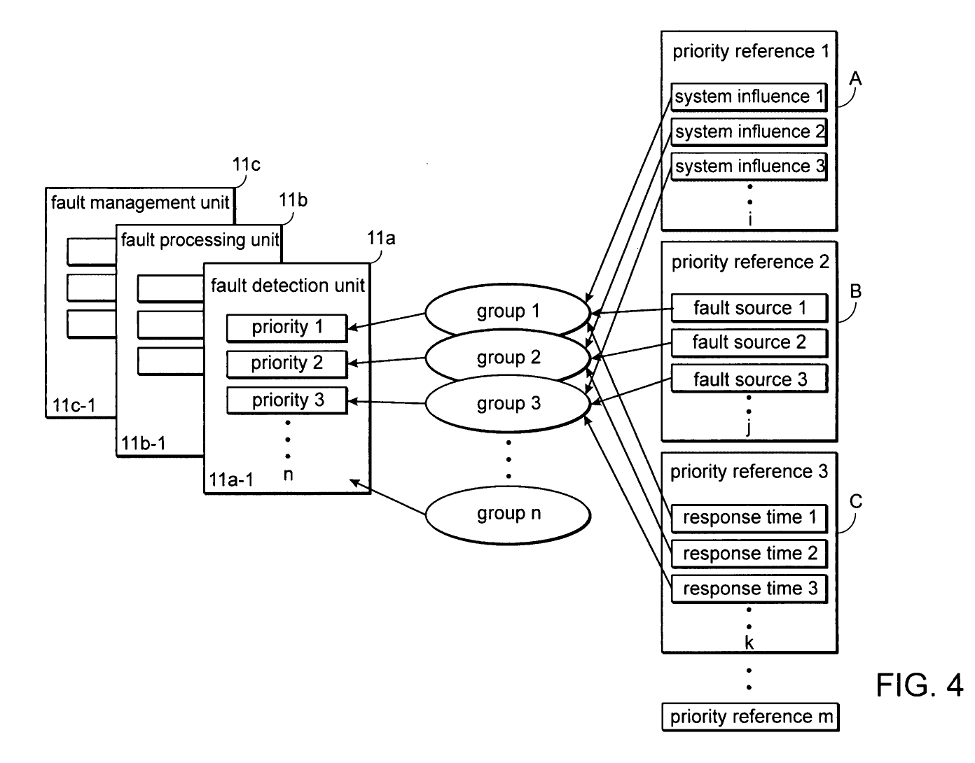

FIG. 4 is a view showing a method of determining a priority by fault in the fault information processing process according to the present invention.

As shown in FIG. 4, a reference for assigning a priority depending on the fault type includes, is not limited to, an influence (A) of a fault on the system, a source (B) inducing a fault, a response time (C), etc.

For example, when a priority is assigned with reference to the influence of a fault on the system, it can be determined in the order of fire, damage, stop, performance degradation, etc. Also, when it is assigned with reference to the fault source, it can be determined in the order of abnormal control signal (over current, over voltage, low voltage and the like), sensor failure (current sensor failure, speed sensor failure, temperature sensor failure and the like), communication failure (non-reception of CAN, non-transmission and the like), etc. Further, when it is assigned with reference to the response time, it can be determined in the order of factors having a short response time such as current (over current and the like), voltage (over voltage, low voltage and the like), etc., and factors having a long response time such as temperature (over temperature, low temperature and the like).

In this case, detection, process and management of a fault assigned with a higher priority precede those with a lower priority. Here, a fault assigned with a higher priority may be detected, processed and managed several times at a short control cycle during the detection of a fault assigned with a lower priority.

For example, if there are a fault assigned with a higher priority having a detection cycle of 1 ms and a fault assigned with a lower priority having a detection cycle of 10 ms, when the fault assigned with a lower priority is detected one time, the fault assigned with a higher priority can be detected ten times.

Like this, the fault detection unit 11a is configured to detect a fault in accordance with specified certain criteria, in which a fault requiring prompt treatment is detected with priority over those requiring less prompt treatment, and a fault having a shorter control cycle is detected with priority over those having a longer control cycle (F1, F2 of FIG. 3). Also, when fault detection unit 11a detects the occurrence of a fault from each system within the hybrid vehicle, it applies a signal informing the occurrence of the fault to the fault processing unit 11b and the fault management unit 11c (F3 of FIG. 3).

The fault processing unit 11b performs a proper process of the fault such as interruption of the control, for example, interruption of the control of the drive motor 15 of FIG. 1, interruption of the supply of power (high voltage power) from the high voltage battery 12 by the main relay 2 or the like, for the protection of the hybrid system (F4 of FIG. 3).

The fault detection unit freezes fault-related data immediately after the occurrence of the fault and stores the frozen fault-related data in the buffer unit 11d (F5 of FIG. 3).

Subsequently, the fault management unit 11c having an independent control cycle retrieves an occurred fault according to a priority depending on the fault type (F6 of FIG. 3), combines the previously frozen fault-related data and the occurred fault, and stores corresponding fault information as a freeze frame in the buffer unit 11d (F7 of FIG. 3).

Then, the fault management unit 11c displays completion of reading (a flag set confirming reading of the freezing data) (F8 of FIG. 3) and manages the occurred fault to observe a relevant statue and regulation.

All the data (including freeze data) necessary for the fault management are stored in the memory 14 included in the MCU 11, for example, an NVRAM such as an EEPROM when the power is turned off.

As described above, the fault information processing system for a vehicle of the present invention can process and control a fault occurred within the vehicle and can store data (including freeze frame) for managing the occurred fault. The fault information processing system includes the fault detection unit 11a, the fault processing unit 11b, the fault management unit 11c and the buffer unit 11d. The fault detection unit 11a, the fault processing unit 11b and the fault management unit 11c perform a fault process at independent control cycles, respectively. The respective constituent elements having independent control cycles process all the faults depending on a priority by each constituent element in such a fashion that fault-related data (freeze frame) is frozen immediately after the occurrence of a fault irrespective of the type of the fault and the priority. Also, the fault management unit 11c retrieves an occurred fault at an independent control cycle, combines the previously frozen freeze frame and the occurred fault, and stores corresponding fault information in the buffer unit 11d. Thus, it is possible to satisfy a short control cycle which is the characteristic of a hybrid vehicle system upon the fault processing operation to thereby reduce the burden applied to the CPU, i.e., the controller within the MCU, and enables significant fault information to be frozen.

The invention has been described in detain with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A fault information processing system for a vehicle, which performs the process and the control of a fault occurred within the vehicle, and stores data for managing the occurred fault, the fault information processing system comprising:
a fault detection unit 11a for detecting the occurrence of a fault from each system within the vehicle and generating a signal informing the occurrence of the fault;
a fault processing unit 11b for receiving the fault occurrence informing signal from the fault detection unit 11a and performing a proper process of the fault to protect the system;
a fault management unit 11c for receiving the fault occurrence informing signal from the fault detection unit 11a and managing fault information necessary for diagnosis and repair of the fault; and
a buffer unit 11d for storing fault-related data frozen by the fault detection unit 11a immediately after the occurrence of the fault.

2. The fault information processing system of claim 1, wherein the fault detection unit 11a, the fault processing unit 11b and the fault management unit 11c have independent control cycles.

3. The fault information processing system of claim 1, wherein the fault detection unit 11a, the fault processing unit 11b and the fault management unit 11c perform the fault detection, fault process and fault management depending on the type of a fault based on a predetermined priority assigned to each of all the faults possible to occur in the vehicle upon the occurrence of a fault.

4. The fault information processing system of claim 3, wherein the fault management unit 11c retrieves the buffer unit 11d to find an occurred fault according to a priority depending on the fault type at an independent control cycle, combines the previously frozen fault-related data and the occurred fault, and stores corresponding fault information in the buffer unit 11d to manage the occurred fault.

5. A fault information processing method for a vehicle, which performs the process and the control of a fault occurred within the vehicle, and stores data for managing the occurred fault, the fault information processing method comprising the steps of:
allowing a fault detection unit 11a to detect the occurrence of a fault from each system within the vehicle and generate a signal informing the occurrence of the fault;
allowing a fault processing unit 11b to receive the fault occurrence informing signal from the fault detection unit 11a and perform a proper process of the fault to protect the system; and
allowing a fault management unit 11c to receive the fault occurrence informing signal from the fault detection unit 11a and manage fault information necessary for diagnosis and repair of the fault.

6. The fault information processing method of claim 5, wherein the fault detection unit 11a, the fault processing unit 11b and the fault management unit 11c perform have independent control cycles.

7. The fault information processing method of claim 5, wherein the fault detection unit 11a freezes fault-related data immediately after the occurrence of the fault so as to allow the frozen fault-related data to be stored in a buffer unit 11d.

8. The fault information processing method of claim 6, wherein the fault detection unit 11a, the fault processing unit 11b and the fault management unit 11c perform a fault detection, a fault process and a fault management depending on the type of a fault based on a predetermined priority assigned to each of all the faults possible to occur in the vehicle upon the occurrence of a fault.

9. The fault information processing method of claim 8, wherein the fault management unit 11c retrieves the buffer unit 11d to find an occurred fault according to a priority depending on the fault type at an independent control cycle, combines the previously frozen fault-related data and the occurred fault, and stores corresponding fault information in the buffer unit 11d to manage the occurred fault.
